(19) United States
(12) Patent Application Publication
(10) Pub. No.: US 2015/0163613 A1
(43) Pub. Date: Jun. 11, 2015

(54) ACOUSTIC CONTROL DEVICE

(71) Applicant: MITSUBISHI JIDOSHA KOGYO KABUSHIKI KAISHA, Tokyo (JP)

(72) Inventors: Kazuomi Akiba, Kariya-shi (JP); Akihiro Okada, Nagoya-shi (JP); Shintaro Kuwabara, Nisshin-shi (JP); Toshifumi Ohba, Okazaki-shi (JP); Yasuhito Matsuoka, Nagoya-shi (JP); Yoshio Sato, Tokyo (JP)

(73) Assignee: MITSUBISHI JIDOSHA KOGYO KABUSHIKI KAISHA, Tokyo (JP)

(21) Appl. No.: 14/412,154

(22) PCT Filed: Mar. 21, 2013
(86) PCT No.: PCT/JP2013/058066

§ 371 Date: Dec. 30, 2014

(30) Foreign Application Priority Data
Jul. 9, 2012 (JP) 2012-153587

(51) Int. Cl. H04S 7/00

(52) U.S. Cl. CPC H04S 7/30

(57) ABSTRACT

When a surround sound is set, operation buttons for setting the surround sound and operation buttons for setting a listening position which are such that setting contents mutually act on setting results are displayed on a setting section at the same time, and in operation determination control and display selection determination control, display based on the surround sound and the listening position is displayed on an illustration section of a touch panel display.

### TECHNICAL FIELD

The present invention relates to an acoustic control device, and more particularly relates to control of sound quality setting display.

### BACKGROUND ART

Conventionally, automobiles have been equipped with acoustic apparatuses for enabling various music sources such as CDs, DVDs and radios to be listened to in vehicle compartments. An acoustic apparatus as above is provided with the acoustic control device as in, for example, Patent Document 1 that controls these music sources.

In the acoustic control device of Patent Document 1, the music source to be listened to is enabled to be set at each seat by a user operating a touch panel display.

### PRIOR ART DOCUMENT

### Patent Document

Patent Document 1: Japanese Patent Laid-Open No. 2009-143495

### SUMMARY OF THE INVENTION

### Problems to be Solved by the Invention

As above, in the acoustic control device of Patent Document 1 described above, at the time of setting a music source to be listened to at each seat, the music source which is desired to be listened to is selected from the list of listenable music sources which are displayed on the touch panel display, after which, display on the touch panel display is shifted to the seat selection screen, and the seat is selected. Namely, the setting screen differs according to the setting item, and when the setting item changes, the setting screen is switched.

However, if the setting method which switches the setting screen like this is applied to the setting items where respective setting items act on each other, in setting of the sound quality such as a surround sound, setting of the seat where music is listened to and the like, for example, a user needs to look for the setting which is desired by the user by switching the respective setting screens, and the operation of the user becomes complicated, which is not preferable.

The present invention is made to solve the problem as above, and an object of the present invention is to provide an acoustic control device which can simplify an operation of a user.

### Means for Solving the Problems

In order to achieve the above object, an aspect of the invention of the present application is directed to an acoustic control device including a sound quality setting portion that sets a sound quality of an acoustic apparatus of a vehicle, a listening position setting portion that sets a listening position in the vehicle, a result display unit that displays setting results based on setting contents in the sound quality setting portion and the listening position setting portion, and a control unit that controls the result display unit, wherein the control unit reflects the setting contents in the setting results each time either one of the sound quality setting portion or the listening position setting portion is operated (claim 1).

The acoustic control device preferably includes a setting display unit that displays the sound quality setting portion and the listening position setting portion operably, wherein the control unit controls the setting display unit to display the sound quality setting portion and the listening position setting portion on the setting display unit at the same time at a time of setting the sound quality or the listening position (claim 2).

Further, the control unit preferably causes the result display unit to display the setting results in such a manner as to display the sound quality in a shape of display and the listening position by a position of display (claim 3).

### Advantageous Effects of the Invention

According to the acoustic control device of the invention of the present application, at the time of setting of the sound quality or the listening position, the setting contents are reflected on the setting results which are displayed on the result display unit each time either one of the sound quality setting portion or the listening position setting portion is operated.

As above, at the time of setting of the sound quality and the listening position which are such that the setting contents mutually act on the setting results, the setting contents are reflected on the result display unit each time either of the sound quality setting portion or the listening position setting portion is operated, whereby the user can visually understand the present setting results, and therefore, the combination of the settings desired by the user can be easily set.

Accordingly, the operation of the user can be simplified (claim 1).

Further, at the time of setting the sound quality or the listening position, the setting display unit is caused to display the sound quality setting portion and the listening position setting portion at the same time.

As above, at the time of setting of the sound quality and the listening position which are such that the setting contents mutually act on the setting result, the sound quality setting portion and the listening position setting portion are displayed at the same time, whereby switching of the setting screen by the user becomes unnecessary, and therefore, the operation of the user can be simplified (claim 2).

Further, the setting results are displayed on the result display unit in such a manner as to display the sound quality in the shape of display and the listening position by the position of display, the user can visually understand the present setting results, and therefore, the combination of the settings desired by the user can be easily set (claim 3).

### BRIEF DESCRIPTION OF THE DRAWINGS

FIG. 1 is a schematic configuration diagram of an acoustic apparatus to which an acoustic control device according to the present invention is applied.

FIG. 2 is a diagram showing one example of a display on a touch panel display.

FIG. 3 is a diagram showing one example of the display on the touch panel display at respective settings.

FIG. 4 is a flowchart showing a control routine of an operation determination control in a controller according to the present invention.

FIG. 5 is a flowchart showing a control routine of display selection determination control in the controller according to the present invention.

### MODE FOR CARRYING OUT THE INVENTION

Hereinafter, an embodiment of the present invention will be described based on the drawings.

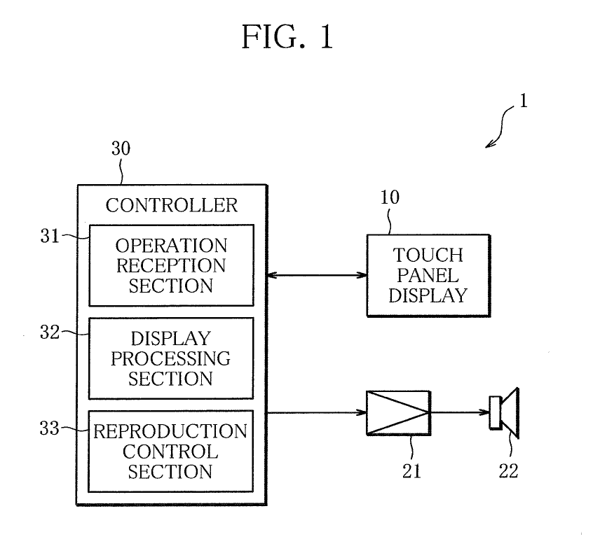

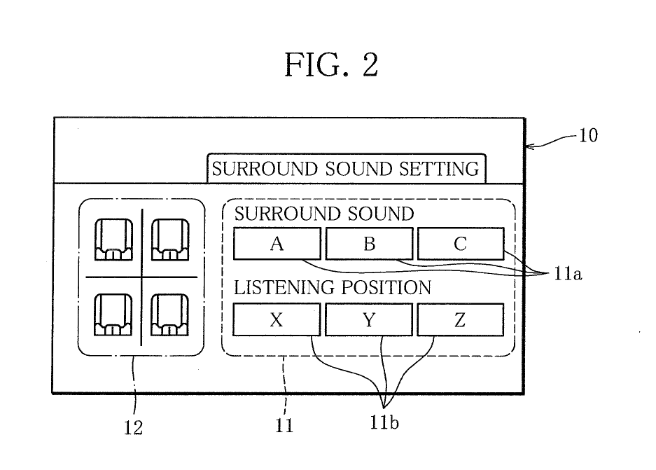

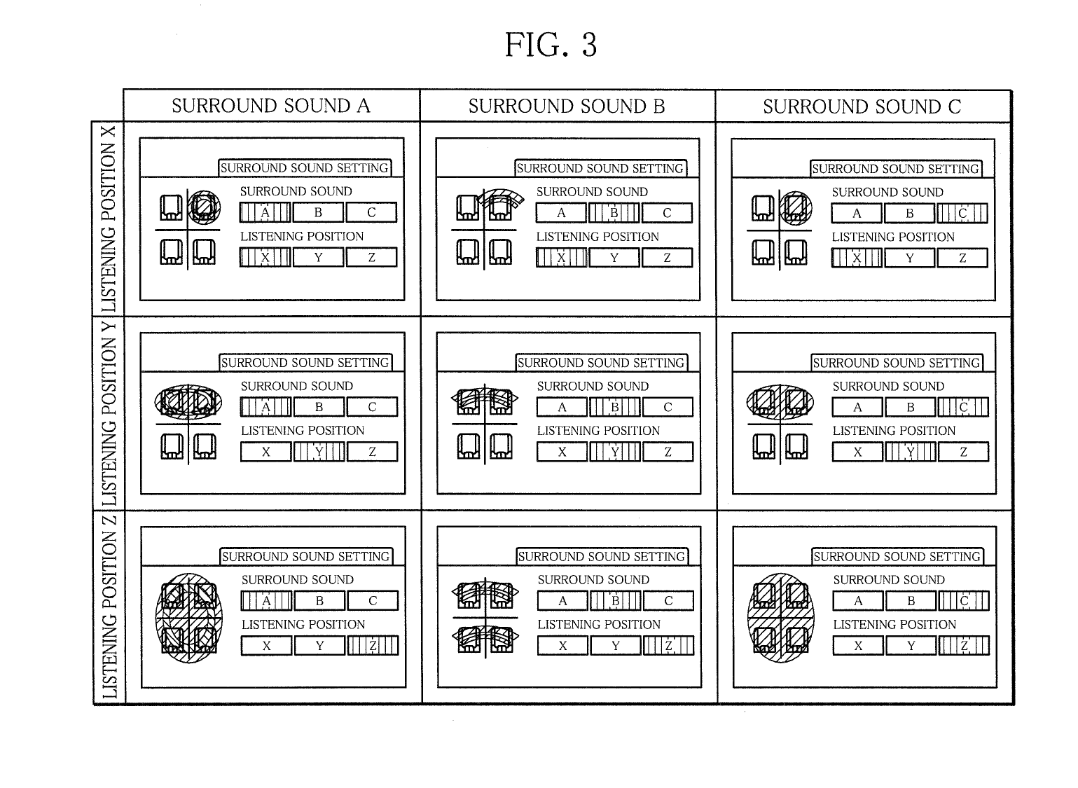

FIG. 1 is a schematic configuration diagram of an acoustic apparatus to which an acoustic control device according to the present invention is applied. Further, FIG. 2 is a diagram showing one example of a display on a touch panel display. A region shown by a broken line in the drawing shows a setting section where settings of a surround sound, a listening position and the like are performed, and a region shown by a two-dot chain line shows an illustration section that displays a combination of settings. Note that though not illustrated, in the present example, a right upper side of the illustration section represents a driver's seat. Further, surround sounds A, B and C show kinds of surround sounds, a listening position X shows only the driver's seat, a listening position Y shows only a front seat, and a listening position Z shows all seats. FIG. 3 is a diagram showing one example of display on a touch panel display 10 at respective settings. In more detail, FIG. 3 shows display of the illustration sections in the respective settings of the surround sound and the listening position. Note that in the present example, the kind of the surround sound is expressed in the shape of display, and the listening position is expressed in the position of display. In more detail, the surround sound A is expressed in a shape of a triple circle, the surround sound B is expressed in a shape of a substantially double sector, and the surround sound C is expressed in a circular shape. Hereinafter, a configuration of the acoustic apparatus to which the acoustic control device is applied will be described.

An acoustic apparatus 1 is for enabling various music sources such as a CD, a DVD and a radio to be listened to in a vehicle compartment of an automobile or the like.

As shown in FIG. 1, the acoustic apparatus 1 is configured by the touch panel display (a setting display unit, a sound quality setting portion, a listening position setting portion, a result display unit) 10, an amplifier 21 that amplifies an audio signal of music or the like, a speaker 22 that outputs the amplified audio signal as a sound, and a controller (a control unit) 30 that controls the touch panel display 10 and the amplifier 21. These various devices are electrically connected.

The touch panel display 10 has functions as an input and display devices. As shown in FIG. 2, for example, when sound setting is performed, operation buttons (a sound quality setting portion) 11a for setting the surround sound and operation buttons (a listening position setting portion) 11b for setting the listening position which are such that setting contents mutually act on setting results are displayed on a setting section 11 at the same time, and an illustration based on an input signal from the controller 30 is displayed on an illustration section (a result display unit) 12 so that the user can recognize a combination of settings. Note that the input signal from the controller 30 is outputted from the controller 30 based on settings of the surround sound and the listening position. Further, in the touch panel display 10, the surround sound and the listening position can be set by pressing the operation buttons 11a and 11b on a touch panel of the touch panel display 10. The touch panel display 10 outputs signals of operation states of the individual operation buttons 11a and 11b, that is, the setting states of the surround sound and the listening position to the controller 30.

The controller 30 is configured by including an input and output device, a storage device (a ROM, a RAM, a nonvolatile RAM, and the like) and a central processing unit (CPU) and the like. FIG. 1 shows an operation reception section 31, a display processing section 32 and a reproduction control section 33 in a blocked state, as processing function sections in the storage device and the central processing unit of the controller 30.

The touch panel display 10 is connected to an input side of the controller 30. The touch panel display 10, and a speaker 22 via an amplifier 21 are connected to an output side of the controller 30.

The operation reception section 31 determines an operation state of the touch panel display 10, and outputs the determination result to the display processing section 32 and the reproduction control section 33. For example, when surround sound setting is performed, the operation reception section 31 determines operation states of the operation buttons 11a and 11b that are displayed on the setting section 11, and supplies the signals of the determination results to the display processing section 32 and the reproduction control section 33.

The display processing section 32 outputs the operation buttons 11a and 11b, illustrations and the like stored in the ROM or the like in advance for the setting section 11 and the illustration section 12 of the touch panel display 10 to the touch panel display 10. As shown in FIG. 2, when a surround sound setting is performed, the display processing section 32 supplies a signal to the touch panel display 10 so as to simultaneously display the operation buttons 11a and the operation buttons 11b for setting the surround sound and the listening position which are such that the setting contents mutually act on the setting results. Further, based on the determination result which is inputted from the operation reception section 31, the display processing section 32 selects the illustration corresponding to the setting performed by the user from the illustrations that are stored in advance, and supplies the signal of the illustration to the touch panel display 10. As shown in FIG. 3, in the present example, for example, when the surround sound is B and the listening position is X, a shape of a substantially double sector is displayed to include only a driver's seat at a upper right side of the illustration section 12, and when the surround sound is C, and the listening position is Z, a circular shape that includes all the seats is displayed.

The reproduction control section 33 controls the amplifier based on the setting of the user. For example, when surround sound setting is performed, the reproduction control section 33 changes a sound quality by controlling the amplifier 21 so that the surround sound and the listening position are as set by the user, based on the determination result which is inputted from the operation reception section 31.

Subsequently, when the surround sound setting is selected by the user on the touch panel display 10 at the time of surround sound setting, for example, the controller 30 determines the operation state of the touch panel display 10 in the operation reception section 31. Subsequently, based on the determination result, the display processing section 32 supplies a signal to the touch panel display 10 to display the operation buttons 11a and the operation buttons 11b for setting the surround sound and the listening position at the same time, and further supplies a signal to the touch panel display 10 to display an illustration as shown in FIG. 3 based on the present settings of the surround sound and the listening position. Subsequently, when the operation button 11a or the operation button 11b on the touch panel display 10 is operated by the user, the controller 30 performs operation determination control of determining the operation states of the operation button 11a and the operation button 11b on the touch panel display 10 in the operation reception section 31. Subsequently, based on the determination result, the reproduction control section 33 controls the amplifier 21 so that the surround sound and the listening position are as set by the user to change the sound quality. Further, based on the determination result in the operation reception section 31, the display processing section 32 performs display selection determination control of supplying a signal to the touch panel display 10 so as to display the illustration based on the settings of the surround sound and the listening position on the illustration section 12 of the touch panel display 10.

Hereinafter, the operation determination control and the display selection determination control in the controller 30 according to the present invention configured as above will be described.

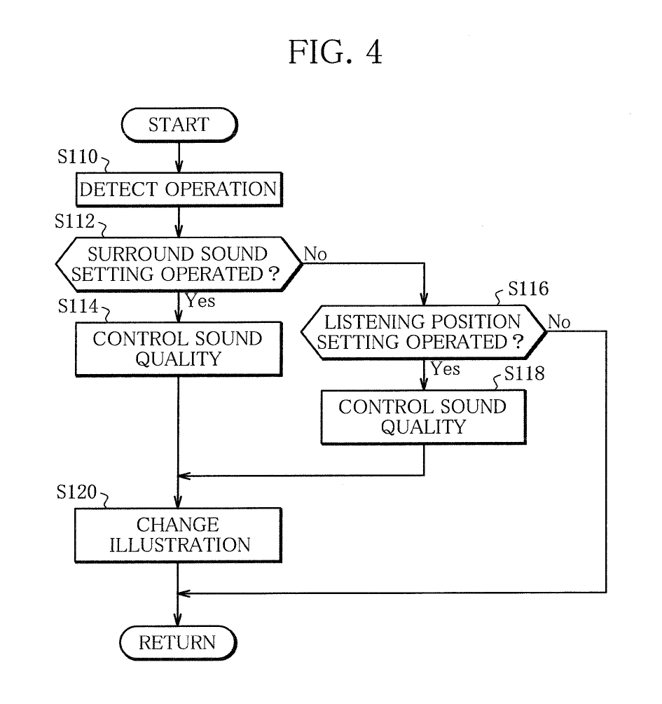

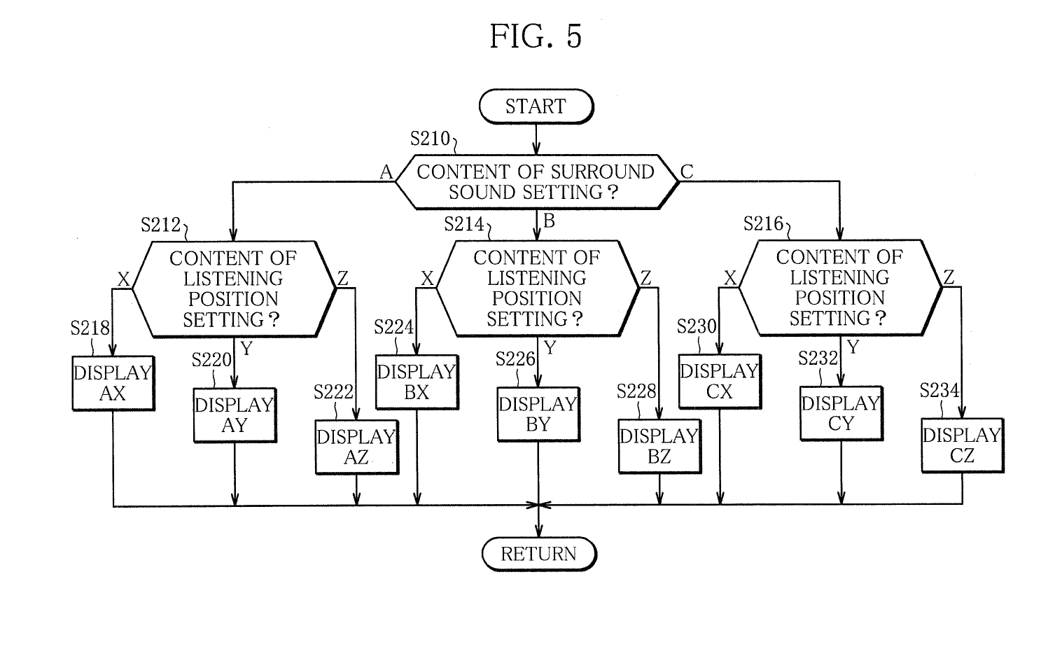

FIG. 4 is a flowchart showing a control routine of the operation determination control in the controller according to the present invention. Further, FIG. 5 is a flowchart showing a control routine of the display selection determination control in the controller according to the present invention. Note that processing of the operation determination control and processing of the display selection determination control are performed each time the operation of the touch panel display 10 is detected.

### [Operation Determination Control]

First, the operation determination control will be described.

As shown in FIG. 4, in step S110, an operation of the operation button 11a or the operation button 11b of the touch panel display 10 is detected. Subsequently, the flow proceeds to step S112.

In step S112, it is determined whether or not setting of the surround sound is operated. Namely, it is determined whether or not any of the operation buttons 11a displayed on the touch panel display 10 is operated. When the determination result is affirmative (Yes), and any of the operation buttons 11a is operated, the flow proceeds to step S114. Further, when the determination result is (No), and none of the operation buttons 11a is operated, the flow proceeds to step S116.

In step S114, the sound quality is controlled to the sound quality suitable for the selected surround sound effect. In more detail, the amplifier 21 is controlled so as to provide a surround sound effect of any of the operation buttons 11a displayed on the touch panel display 10. Subsequently, the flow proceeds to step S120.

Further, in step S116, it is determined whether or not setting of the listening position is operated. That is to say, it is determined whether or not any of the operation buttons 11b displayed on the touch panel display 10 is operated. When the determination result is affirmative (Yes), and any of the operation buttons 11b is operated, the flow proceeds to step S118. Further, when the determination result is negative (No), and none of the operation buttons 11b is operated, the present routine is returned.

In step S118, the sound quality is controlled to the sound quality suitable for the selected listening position. In more detail, the amplifier 21 is controlled so that the listening position is any of the listening positions of the operation buttons 11b displayed on the touch panel display 10. Subsequently, the flow proceeds to step S120.

In step S120, the illustration is changed. In more detail, the illustration displayed on the illustration section 12 of the touch panel display 10 is changed based on the display selection determination control which will be described later. Subsequently, the present routine is returned.

### [Display Selection Determination Control]

Next, the display selection determination control will be described.

As shown in FIG. 5, in step S210, it is determined what the content of the setting of the surround sound is. In more detail, it is determined which one of A, B and C the setting of the surround sound selected at present is. When the determination result is A, and the setting of the surround sound is A, the flow proceeds to step S212. Further, when the determination result is B, and the setting of the surround sound is B, the flow proceeds to step S214. Further, when the determination result is C, and the setting of the surround sound is C, the flow proceeds to step S216.

In step S212, it is determined what the content of the setting of the listening position is. In more detail, it is determined which one of X, Y and Z the setting of the listening position selected at present is. When the determination result is X, and the setting of the listening position is X, the flow proceeds to step S218, and display on the illustration section 12 of the touch panel display 10 is made a display AX, that is, the display in the case of the surround sound being A and the listening position being X. Subsequently, the present routine is returned. Further, when the determination result is Y, and the setting of the listening position is Y, the flow proceeds to step S220, and the display on the illustration section 12 of the touch panel display 10 is made a display AY, that is, a display in the case of the surround sound being A, and the listening position being Y. Subsequently, the present routine is returned. Further, when the determination result is Z, and the setting of the listening position is Z, the flow proceeds to step S222, and the display on the illustration section 12 of the touch panel display 10 is made a display AZ, that is, a display in the case of the surround sound being A, and the listening position being Z. Subsequently, the present routine is returned.

In step S214, similarly to step S212, it is determined what the content of the setting of the listening position is. In more detail, it is determined which one of X, Y and Z the setting of the listening position selected at present is. When the determination result is X, and the setting of the listening position is X, the flow proceeds to step S224, and the display on the illustration section 12 of the touch panel display 10 is made a display BX, that is, a display in the case of the surround sound being B, and the listening position being X. Subsequently, the present routine is returned. Further, when the determination result is Y, and the setting of the listening position is Y, the flow proceeds to step S226, and the display on the illustration section 12 of the touch panel display 10 is made a display BY, that is, a display in the case of the surround sound being B, and the listening position being Y. Subsequently, the present routine is returned. Further, when the determination result is Z, and the setting of the listening position is Z, the flow proceeds to step S228, and the display on the illustration section 12 of the touch panel display 10 is made a display BZ, that is, a display in the case of the surround sound being B, and the listening position being Z. Subsequently, the present routine is returned.

In step S216, similarly to step S212, it is determined what the content of the setting of the listening position is. In more detail, it is determined which one of X, Y and Z the setting of the listening position selected at present is. When the determination result is X, and the setting of the listening position is X, the flow proceeds to step S230, and the display on the illustration section 12 of the touch panel display 10 is made a display CX, that is, a display in the case of the surround sound being C, and the listening position being X. Subsequently, the present routine is returned. Further, when the determination result is Y, and the setting of the listening position is Y, the flow proceeds to Step S232, and the display on the illustration section 12 of the touch panel display 10 is made a display CY, that is, a display in the case of the surround sound being C, and the listening position being Y. Subsequently, the present routine is returned. Further, when the determination result is Z, and the setting of the listening position is Z, the flow proceeds to step S234, and a display on the illustration section 12 of the touch panel display 10 is made a display CZ, that is, a display in the case of the surround sound being C, and the listening position being Z. Subsequently, the present routine is returned.

As above, in the acoustic control device according to the present invention, when the surround sound setting is performed, the operation buttons 11a for setting the surround sound and the operation buttons 11b for setting the listening position, which are such that the setting contents mutually act on the setting results, are displayed on the setting section 11 of the touch panel display 10 at the same time, and in the operation determination control and the display selection determination control, the display based on the settings of the surround sound and the listening position is displayed on the illustration section 12 of the touch panel display 10.

Accordingly, for example, at the time of setting of the surround sound and setting of the listening position, which are such that the setting contents mutually act on the setting results, the setting contents are reflected on the illustration section 12 of the touch panel display 10 each time either the operation button 11a for setting the surround sound or the operation button 11b for setting the listening position is operated, whereby the user can visually understand the present setting result, and the combination of the settings desired by the user can be easily set, and therefore, the operation of the user can be simplified.

Further, for example, at the time of setting of the surround sound and the listening position, the operation buttons 11a for setting the surround sound and the operation buttons 11b for setting the listening position are displayed at the same time, whereby switching of the setting screen by the user becomes unnecessary, and therefore, the operation of the user can be simplified.

Further, the setting results are displayed on the illustration section 12 of the touch panel display 10, in such a manner that the kind of the surround sound is expressed in the shape of the display, the listening position is expressed in the position of the display, and the user can visually understand the present setting results, and therefore, the combination of the settings desired by the user can be easily set.

That concludes the description of the embodiment of the present invention, and the mode of the invention is not limited to the present embodiment.

While in the present embodiment, the settings of the kind of the surround sound and the listening position at the time of setting the surround sound are described, but the present invention is not limited to this, and it goes without saying that there will be no problem even if the present invention is applied to the setting items which are such that the setting contents mutually act on the setting results, as a matter of course.

Further, while three kinds of surround sounds of A, B and C, and the three kinds of listening positions of X, Y and Z are adopted, the kind of the surround sound and the listening position are not limited thereto, and it goes without saying that the numbers of surround sounds and listening positions may be larger or smaller than those in the present embodiment as a matter of course.

Further, while the settings of the surround sound and the listening position are performed on the touch panel display 10, the present invention is not limited to this, and the setting of the surround sound or the listening position may be performed by a button switch or a voice operation, for example.

Further, while the setting section 11 and the illustration section 12 are displayed on the same touch panel display 10, the present invention is not limited to this, and it goes without saying that the setting section 11 and the illustration section 12 may be displayed on different display devices, for example.

### EXPLANATION OF REFERENCE SIGNS

1 Acoustic apparatus
10 Touch panel display (a setting display unit, a sound quality setting portion, a listening position setting portion, a result display unit)
11 Setting section
11a Operation button (a sound quality setting portion)
11b Operation button (a listening position setting portion)
12 Illustration section (a result display unit)
30 Controller (a control unit)

1.-6. (canceled)

7. An acoustic control device, comprising:
a sound quality setting portion that sets a sound quality of an acoustic apparatus of a vehicle;
a listening position setting portion that sets a listening position where a sound is listened to in the vehicle;
a touch panel display that displays the sound quality setting portion and the listening position setting portion operably;
a result display unit that displays setting results on the touch panel display, based on setting contents selected by the sound quality setting portion and the listening position setting portion; and
a control unit that controls the result display unit,
wherein the control unit reflects the setting contents in the setting results each time either one of the sound quality setting portion or the listening position setting portion is operated, and causes the setting results to be displayed on a site corresponding to the listening position.

8. The acoustic control device according to claim 7,
wherein the control unit controls the touch panel display to display the sound quality setting portion and the listening position setting portion on the touch panel display at the same time at a time of setting the sound quality or the listening position.

9. The acoustic control device according to claim 7,
wherein the control unit causes the result display unit to display the setting results in such a manner as to display the sound quality in a shape of an illustration set in advance, and the listening position by a position displayed.

10. The acoustic control device according to claim 7,
wherein the touch panel display comprises a setting section comprising the sound quality setting portion and the listening position setting portion, and the result display unit which displays the setting results.

11. The acoustic control device according to claim 7,
wherein the listening position is configured by any one of positions of at least a driver's seat, front seats including the driver's seat, and all seats.

12. The acoustic control device according to claim 9,
wherein the shapes of the illustrations corresponding to the setting results are different shapes of display respectively according to the sound quality and the listening position.

13. The acoustic control device according to claim 8,
wherein the control unit causes the result display unit to display the setting results in such a manner as to display the sound quality in a shape of an illustration set in advance, and the listening position by a position displayed.

14. The acoustic control device according to claim 13,
wherein the shapes of the illustrations corresponding to the setting results are different shapes of display respectively according to the sound quality and the listening position.
